(19) United States
(12) Patent Application Publication
(10) Pub. No.: US 2009/0054045 A1
(43) Pub. Date: Feb. 26, 2009

(54) Device and Method for Warm Boot Persistence

(76) Inventors: Slawomir Zakrzewski, Melville, NY (US); Charles S. Bolen, Kings Park, NY (US)

Correspondence Address: Fay Kaplun & Marcin, LLP/ Motorola, 150 Broadway Suite 702, New York, NY, 10038, US

(21) Appl. No.: 11/843,069

(22) Filed: Aug. 22, 2007

(51) Int. Cl. H04M 3/00; G06F 12/00

(52) U.S. Cl. 455/418; 711/173; 711/E12.001

(57) ABSTRACT

A mobile device comprises a volatile memory and a processor. The volatile memory is partitioned into first and second storage spaces. The first storage space stores a first data while the second storage space stores a second data. The processor detects a value. The value indicates that the volatile memory is to be partitioned so that a driver for the volatile memory creates the first and second storage spaces. The second data is persisted during a warm reboot of the mobile device.

### FIELD OF THE INVENTION

The present invention relates generally to a system and method for warm boot persistence. Specifically, a random access memory of a mobile unit is partitioned to provide a storage space so that data saved thereon is retained upon a warm boot.

### BACKGROUND

Mobile units (MU) are constantly being improved to have a smaller size and a lighter weight. While becoming smaller and lighter, the MUs may have to sacrifice otherwise available functionalities. For example, an MU may include a random access memory (RAM) but may not have a disk drive for data storage. Furthermore, the MU may include components that are unused at certain times or are not used to a full potential. For example, a processor and other components of the MU require a finite amount of RAM capacity. Consequently, the MU rarely utilizes the entire capacity of the RAM. That is, a portion of the capacity of the RAM is unused.

The MU may be able to boot in different ways. In particular, the effect of the type of boot on the RAM is different. For example, a clean boot provides a factory reset and the data on the RAM is erased. It should be noted that a clean boot done programmatically may preserve certain fundamental data. However, the fundamental data must be loaded using a start up application. In addition, other data that was stored is erased. A cold boot provides a hardware reset and the data on the RAM is erased. However, a warm boot provides a software reset and the data on the RAM is persisted.

### SUMMARY OF THE INVENTION

The present invention relates to a device and method for warm boot persistence. A mobile device comprises a volatile memory and a processor. The volatile memory is partitioned into first and second storage spaces. The first storage space stores a first data while the second storage space stores a second data. The processor detects a value. The value indicates that the volatile memory is to be partitioned so that a driver for the volatile memory creates the first and second storage spaces. The second data is persisted during a warm reboot of the mobile device.

### DESCRIPTION OF THE DRAWINGS

FIG. 1 shows components of a mobile unit according to an exemplary embodiment of the present invention.

FIG. 2 shows a method of warm boot persistence according to an exemplary embodiment of the present invention.

### DETAILED DESCRIPTION

The present invention may be further understood with reference to the following description and the appended drawings, wherein like elements are referred to with the same reference numerals. The exemplary embodiments of the present invention describe a system and method for warm boot persistence on a mobile unit (MU). Specifically, the exemplary embodiments of the present invention may pertain to the MU having a random access memory (RAM) and further partitioning the RAM to provide a pseudo-disk drive (hereinafter “RAMDisk”). Consequently, the MU may include an additional hardware component without physically including a further component, thereby maintaining a size of the MU. The MU, the RAM, and the RAMDisk will be discussed in more detail below. Those skilled in the art will understand that while the exemplary embodiments are described with reference to RAM, the present invention may be implemented using any type of volatile memory.

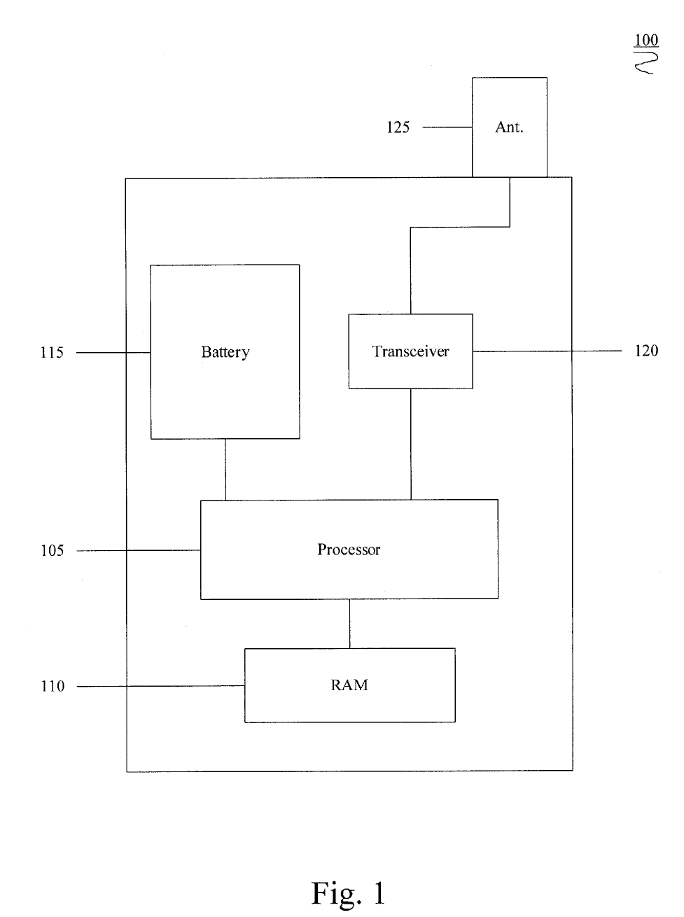

FIG. 1 shows components of an MU 100 according to an exemplary embodiment of the present invention. The MU 100 may be any portable electronic device that utilizes a portable power supply (e.g., battery, capacitor, super capacitor, etc.). For example, the MU 100 may be a mobile computer, a personal digital assistant (PDA), a laptop, a pager, a cell phone, a radio frequency identification device, a scanner, etc. In this exemplary embodiment, the MU 100 does not include a disk drive capable of persisting data when the MU 100 is rebooted with a cold or warm boot. The MU 100 may include a processor 105, a RAM 110, a battery 115, a transceiver 120, and an antenna 125.

It should be noted that the use of the MU 100 is only exemplary. That is, the exemplary embodiments of the present invention may apply to any electronic device that may not utilize a disk drive. Thus, the exemplary embodiments of the present invention may also apply to electronic devices that do not require a portable power supply and does not include the disk drive. Furthermore, it should also be noted that the MU 100 not including a disk drive is only exemplary. That is, as will be discussed in detail below, the exemplary embodiments of the present invention may create the RAMDisk in addition to a disk drive (or other type of non-volatile memory).

The processor 105 may be responsible for executing various functionalities of the MU 100. Specifically, according to the exemplary embodiments of the present invention, the processor 105 may be responsible for a registry that details the various components included in the MU 100. The RAM 110 may be a storage unit for the MU 100. Specifically, the RAM 110 may store data and/or settings pertaining to various programs such as the operating system, a word processing program, etc. The RAM 110 will be discussed in further detail below. As discussed above, the MU 100 may include a portable power supply. As illustrated, the MU 100 may include the battery 115 to supply the necessary energy to operate the MU 100.

The transceiver 120 and the antenna 125 may be components of the MU 100 that allow the MU 100 to connect to a wireless network. The transceiver 120 may connect to a wireless network utilizing conventional connection methods. It should be noted that the antenna 125 being external is only exemplary and the antenna 125 may be internal. Furthermore, it should be noted that the MU 100 may not include the transceiver 120 and the antenna 125. The illustration of the transceiver 120 and the antenna 125 is to show that the MU 100 may include additional components to provide additional functionalities.

The drivers associated with the RAM 110 installed on the operating system may dictate how the RAM 110 performs for the MU 110. For example, the drivers of the RAM 110 may dictate that a predetermined capacity must be set aside for use by the operating system. Furthermore, the drivers of the RAM 110 may dictate that a remaining capacity must be set aside for any program that is launched on the MU 100. According to the exemplary embodiments of the present invention, the RAM 110 may also be equipped to be partitioned. The drivers for the RAM 110 may be modified so that a portion of the total capacity of the RAM 110 is set aside for other storage purposes. That is, the RAM 110 may function as the storage device of the data and/or settings of the various programs installed on the MU 100 and additionally be the RAMDisk. The size of the RAMDisk may vary depending on the MU 100, a total size of the RAM 110, the programs installed on the MU 100, etc. Generally, the size of the RAMDisk may be a difference between a maximum capacity of the RAM 110 less the maximum necessary capacity to run the programs of the MU 100. The modification of the drivers for the RAM 110 and the creation of the RAMDisk will be discussed in detail below.

Because the MU 100 utilizes the RAM 110, the persistence of any data and/or settings stored thereon may only be accomplished when the MU 100 experiences a warm boot (i.e., a software reset where data and/or settings stored thereon is persisted). That is, a clean or cold boot will erase the data and/or settings stored thereon. Thus, the RAMDisk may only be pertinent when the MU 100 experiences a warm boot. The association of the RAMDisk with the warm boot will be discussed in detail below.

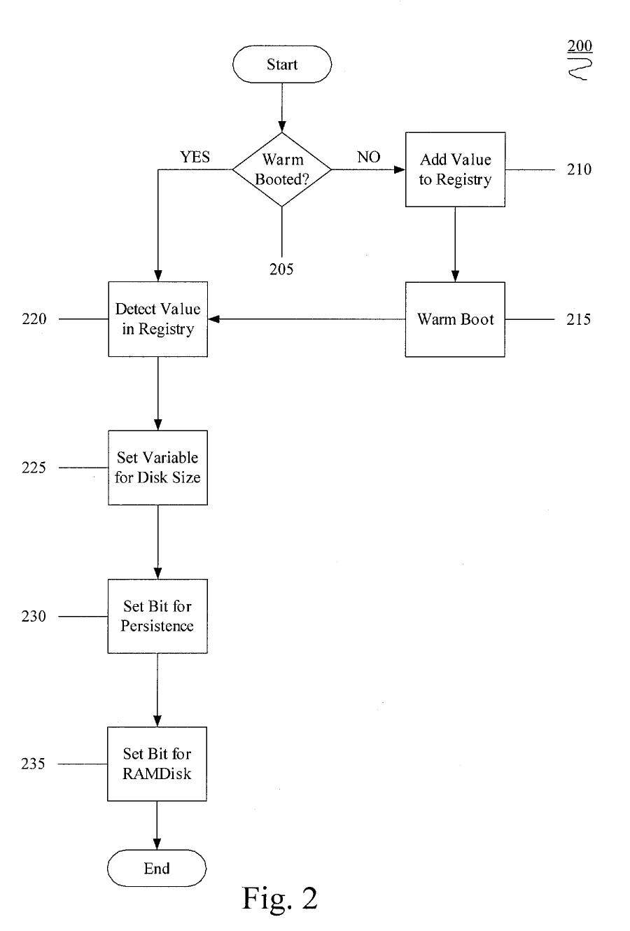

FIG. 2 shows a method 200 of warm boot persistence according to an exemplary embodiment of the present invention. The method 200 will be described with reference to the MU 100 of FIG. 1. The method 200 may apply to the MU 100 that includes the RAM 110 and does not include a disk drive. The method 200 may also apply to any electronic device utilizing a memory substantially similar to the RAM 110 (e.g., any other type of volatile memory).

In step 205, a determination is made whether the MU 100 has been warm booted. As discussed above, the persistence of the data and/or settings on the RAM 110 may only occur if the MU 100 has been rebooted with a warm boot. Thus, the determination of step 205 may also imply whether the RAM 110 has persisted data and/or settings.

If step 205 determines that the MU 100 has not been warm booted, then the method 200 continues to step 210. In step 210, a value is added to the registry of the operating system. Step 210 may assume that the MU 100 has been rebooted with a clean or a cold boot, thereby indicating that the data and/or settings stored on the RAM 110 have been erased. Thus, in order to initiate a creation of the RAMDisk, the value is added to the registry. For example, a registry value may be RetainDataThroughWarmBoot=1 dword value. This value may be entered into the registry within the HKLM\Drivers\BuiltIn\RAMDisk section. Once the value is added, the method 200 continues to step 215 where the MU 100 is warm booted.

It should be noted that the entering of the value to the registry may be done manually by a user, an administrator, etc. of the MU 100. The user may locate a correct location within the registry (e.g., HKLM\Drivers\BuiltIn\RAMDisk) and enter the value described above. It should also be noted that the value to the registry may be entered in other ways. For example, a program may be executed upon the MU 100 being rebooted. The program may add the value to the registry automatically as part of the startup procedure for the MU 100. In another example, a file may be downloaded that performs a substantially similar function.

Whether the MU 100 was warm booted from the determination made in step 205 or after the value being registered in step 215, the method 200 continues to step 220. In step 220, the processor 105 may scan through the registry and detect the value therein. The detection of the value in the registry may initiate a series of steps to create the RAMDisk. It should be noted that when step 205 determined that the MU 100 has been warm booted, it may be assumed that the registry already includes the value described above. However, the method 200 may not make this assumption and an additional step may be included that scans the registry for the value. If the value does not exist, the method 200 may go to step 210 so that the value is added.

Steps 225-235 may be the subsequent steps taken when the processor detects the value in the registry. In step 225, the processor may enable the driver for the RAM 110 to set a variable to indicate a size for the RAMDisk. For example, the variable may be misc.dwRAMDiskSize. This variable may be located in the Driver Globals for the RAM 110. As discussed above, the size of the RAMDisk may be dependent on several factors. For example, assuming the MU 100 only includes an operating system, the size of the RAMDisk may be the total capacity of the RAM 110 less a maximum capacity required for the operating system. In another example, the size of the RAMDisk may be the total capacity of the RAM 110 less a maximum capacity required for the operating system and any installed applications. In a further example, the size of the RAMDisk may be settable by a user or system administrator. In a still further example, a calculation may be performed based on the installed applications to determine an optimum size for the RAMDisk.

In step 230, the processor may also enable the driver to set a bit indicating that the RAMDisk is to be persistent. That is, if the MU 100 experiences a warm boot and data and/or settings have been saved on the RAMDisk, the data and/or settings may be maintained. The bit may be part of the variable in the Driver Globals for the RAM 110. In step 235, the processor may further enable the driver to set a bit in the same variable located in the Driver Globals to indicate that the RAM 110 is to be partitioned to create the RAMDisk. Once created, the RAMDisk may serve as the pseudo-disk drive so that data and/or settings may be stored thereon.

It should be noted that if the RAMDisk has been created on the MU 100 and the MU 100 is rebooted through a clean boot, then the value in the registry to indicate that the RAMDisk should be re-created is added as the data and/or settings on the RAM 110 have been erased during the clean boot. Subsequent variables may also have to be added (e.g., bit indicating RAMDisk size). Furthermore, the MU 100 may have to be warm booted so that the processor may detect the value, thereby enabling the driver to create the RAMDisk. When the MU 100 is rebooted through a cold boot, the value may be retained in the registry so that a warm boot of the MU 100 may allow the processor to detect the value, thereby enabling the driver to create the RAMDisk.

Those skilled in the art will understand that the above described exemplary embodiments may be implemented in any number of manners, including, as a separate software module, as a combination of hardware and software, etc. For example, the RAMDisk may be created using the method 200 through a file that is downloaded onto the MU 100. The file may be a program containing lines of code that, when compiled, may be executed on a processor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A mobile device, comprising:
a volatile memory partitioning into first and second storage spaces, the first storage space storing a first data, the second storage space storing a second data; and
a processor detecting a value, the value indicating that the volatile memory is to be partitioned so that a driver for the volatile memory creates the first and second storage spaces, wherein the second data is persisted during a warm reboot of the mobile device.

2. The mobile device of claim 1, wherein the first data includes an operating system of the mobile device.

3. The mobile device of claim 1, wherein the volatile memory is a random access memory (RAM).

4. The mobile device of claim 1, wherein the driver sets a variable indicating a size of the second storage space.

5. The mobile device of claim 1, wherein the driver sets a bit indicating that the second data is persisted when the mobile device is rebooted with a warm boot.

6. The mobile device of claim 4, wherein the size of the second storage space is based on a size of the first storage space.

7. The mobile device of claim 6, wherein the size of the second storage space is a difference between a total capacity of the volatile memory and the size of the first storage space.

8. The mobile device of claim 1, wherein the value is added if the mobile device is rebooted with one of a clean and cold boot.

9. The mobile device of claim 1, wherein the value is stored in a processor registry.

10. A method, comprising:
setting a value in a processor registry of a mobile device, the value indicating that a volatile memory is to be partitioned into first and second storage spaces;
detecting the value upon rebooting the mobile device with a warm boot; and
creating the first and second storage spaces.

11. The method of claim 10, wherein the first storage space includes an operating system of the mobile device.

12. The method of claim 10, further comprising:
persisting data in the second storage space during a warm reboot of the mobile device.

13. The method of claim 10, wherein the volatile memory is a RAM.

14. The method of claim 10, further comprising:
setting a variable indicating a size of the first and second storage spaces.

15. The method of claim 10, further comprising:
setting a bit indicating that data stored in the second storage space is persisted when the mobile device is rebooted with any subsequent warm boot.

16. The method of claim 10, further comprising:
determining a size of the second storage space based on a size of the first storage space, the size of the second storage space being a difference between a total capacity of the volatile memory and the size of the first storage space.

17. The method of claim 10, further comprising:
resetting the value after one of a clean and cold boot of the mobile device.

18. A mobile device, comprising:
a storing means for partitioning into first and second storage means, the first storage means for storing a first data, the second storage means for storing a second data; and
a processing means for detecting a value, the value indicating that the storing means is to be partitioned so that a driver for the storing means creates the first and second storage means, wherein the second data is persisted during a warm reboot of the mobile device.

19. A computer readable storage medium including a set of instructions executable by a processor, the set of instructions operable to:
set a value to a processor registry of a mobile device, the value indicating that a volatile memory is to be partitioned into first and second storage spaces;
detect the value upon rebooting the mobile device with a warm boot; and
create the first and second storage spaces.
